(19) United States
(12) Patent Application Publication
(10) Pub. No.: US 2013/0155217 A1
(43) Pub. Date: Jun. 20, 2013

(54) AUDIO PLAYER AND CONTROL METHOD THEREOF

(71) Applicants: Fu Tai Hua Industry (Shenzhen) Co., Ltd., Shenzhen (CN); Hon Hai Precision Industry Co., Ltd., New Taipei (TW)

(72) Inventor: YIN-ZHAN WANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/693,045

(22) Filed: Dec. 4, 2012

(30) Foreign Application Priority Data
Dec. 20, 2011 (CN) 201110429355.9

(51) Int. Cl. H04N 7/00

(52) U.S. Cl. CPC H04N 7/002
USPC 348/77

(57) ABSTRACT

An audio player comprises a memory, a camera, a processor and an audio player. The memory stores a playing mode lookup table, loads a plurality of standard facial information to different age groups and a plurality of playing modes, and each playing mode corresponding to an age group. The camera captures a facial picture of a user. The processor analyzes and distinguishes facial information of the facial picture to select a corresponding playing mode according to the distinguished facial information. The audio controller controls volume and playing time length according to the playing mode selected by the processor.

### BACKGROUND

1. Technical Field

The present disclosure relates to an audio player, and more particularly, to an audio player and a control method for the audio player to set different playing modes according to different ages.

2. Description of Related Art

Audio players are widely used and earphones are often used in conjunction with the audio players. When a user listens to loud music using the earphone, it may result in hearing lost.

Therefore, an audio player and control method of an audio player is desired.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of an audio player according to an exemplary embodiment of the present disclosure.

FIG. 2 is a flowchart showing a method for controlling the audio player of the present disclosure of FIG. 1.

### DETAILED DESCRIPTION

Reference will be made to the drawings to describe various embodiments in detail.

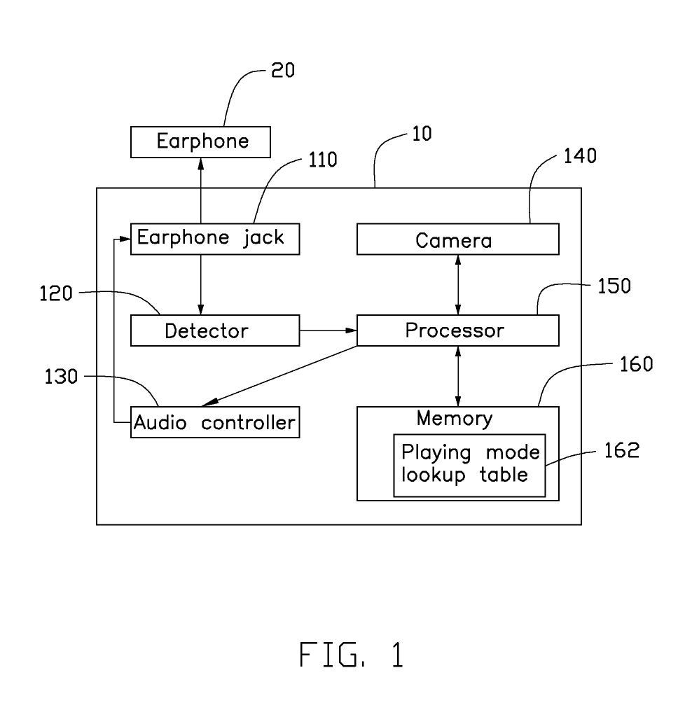

FIG. 1 illustrates a block diagram of an audio player 10 according to an exemplary embodiment of the present disclosure. The audio player 10 includes an earphone jack 110, a detector 120, an audio controller 130, a camera 140, a processor 150, and a memory 160.

The earphone jack 110 includes a connection port to connect with an earphone 20 and generates a detection signal when the earphone 20 is connected with the earphone jack 110. The detector 120 detects the detection signal generated by the earphone jack 110 and outputs the detection signal to the processor 150. The processor 150 determines whether the earphone 20 is connected with the earphone jack 110 according to the detection signal. The audio controller 130 controls audio volume and a playing time length of audio files, such as music files played by the audio player 10 and outputted by the earphone 20 via the earphone jack 110. The camera 140 is configured to capture a facial picture of a user of the audio player 10 and send the facial picture to the processor 150. The memory 160 stores a playing mode lookup table 162 and a plurality of audio files.

The playing mode lookup table 162 stores standard facial information corresponding to different age groups, for example, children, youngsters, adult, and the elderly, and a plurality of playing modes, and stores a corresponding relationship between the playing modes and every age group. The standard facial information may be a pupil distance. Each playing mode includes a predetermined maximum volume and a playing time length.

In one embodiment, the children's age group is set in a range from 3 to 8 years old. The youngster's age group is set in a range from 9 to 19 years old. The adult's age group is set in a range from 20 to 60 years old and the elder's age group is set in a range from 61 to 80 years old. The audio player 10 has a predetermined maximum volume. Each age group corresponds to a presetting playing mode with a proper maximum volume and a playing time length. For example, the maximum volumes of different age groups gradually increases following an increase of the age, and each maximum volume is less than a volume that may cause damage to the users' hearing. The playing time length is properly set to make the users in each age group feel comfortable. In the playing mode corresponding to the children's group, a first maximum volume is about 70% of the predetermined maximum volume, and therefore the volume is set to be less than the first maximum volume and the playing time length is about 30 minutes. In the playing mode of youngster group, a second maximum volume is about 80% of the predetermined maximum volume, and therefore the volume is set to be less than the second maximum volume and the playing time length is about 60 minutes. In the playing mode of adult group, a third maximum volume is equal to the predetermined maximum volume and the playing time length is 120 minutes, and therefore the volume is set to be less than the third maximum volume. In the playing mode of elderly group, a fourth maximum volume is about 120% of the predetermined maximum volume and the playing time length is 120 minutes, and therefore the volume is set to be less than the fourth maximum volume.

The processor 150 analyzes and distinguishes the facial information of the facial picture, looks up the playing mode lookup table 162 to select a corresponding playing mode according to the distinguished facial information. And then the processor 150 outputs a mode control signal to the audio controller 130, the audio controller controls the volume and the playing time length according to the playing mode selected by the processor 150. When the playing music exceeds the playing time length, the audio player 10 stops playing the audio files and reminds the user there is danger to hearing and the user should pay attention to ear health.

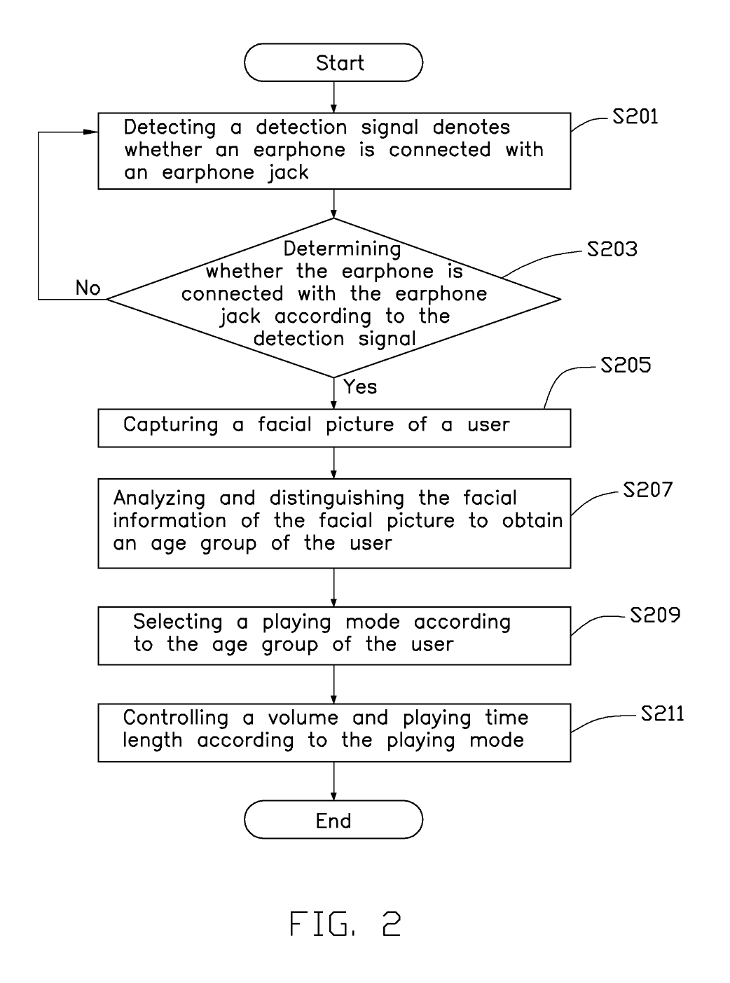

FIG. 2 is a flowchart showing a method for controlling the audio player 10 of present disclosure of FIG. 1. The method includes the following steps, but it should be understood that in other embodiments, additional steps may be added, others deleted, and the ordering of the steps may be changed.

In step S201, the detector 120 detects a detection signal generated by the earphone jack 110 and sends the detection signal to the processor.

In step S203, the processor 150 determines whether an earphone 20 is connected with the earphone jack 110 according to the detection signal. When the detection signal is a logic high signal (e.g., logic 1, a first signal), the processor 150 determines the earphone 20 is connected with the earphone jack 110 and then step S205 is performed. When the detection signal is a logic low signal (e.g., logic 0, a second signal), the processor 150 determines the earphone jack 110 is free, step 201 is performed.

In step S205, the camera 140 captures a facial picture of the user and sends the facial picture to the processor 150, and then step S207 is performed.

In step S207, the processor 150 analyzes and distinguishes the facial information of the facial picture, looks up the playing mode lookup table 162 to obtain the age group of the user and selects a corresponding playing mode according to the distinguished facial information.

In step S209, the processor 150 selects a playing mode according to the age group of the user. In addition, the processor 150 outputs a mode control signal to the audio controller 130, step S211 is performed.

In step S211, the audio controller 130 controls the volume and the playing time length according to the playing mode selected by the processor 150. When playing the audio files exceeds the playing time, the audio player 10 stops playing the audio files and reminds the user to pay attention to ear health.

In summary, the audio player and control method of the audio player could obtain the age group of the user to select a playing mode correspondingly. The audio player controls the volume and the playing time to protect user's listening according to the playing mode.

It is to be understood that even though numerous characteristics and advantages of the present embodiments have been set forth in the foregoing description, with details of the structures and functions of the embodiments, the disclosure is illustrative only; and that changes may be in detail, especially in the matters of arrangement of parts within the principles of the embodiments to the full extent indicated by the broad general meaning of the terms in which the appended claims are expressed.

What is claimed is:

1. An audio player, comprising:
a memory storing standard facial information of people according to different age groups and a plurality of playing modes, where each of the playing modes corresponds to an age group,
a camera capturing a facial picture of a user;
a processor distinguishing facial information of the facial picture and selecting a corresponding playing mode according to the distinguished facial information; and
an audio controller controlling volume and playing time length of the audio player according to the playing mode selected by the processor.

2. The audio player of claim 1, wherein in each of the playing modes, a predetermined maximum volume and a playing time length are preset.

3. The audio player of claim 2, wherein the standard facial information is a pupil distance corresponding to the different age groups.

4. The audio player of claim 3, wherein the standard facial information corresponding to the different age groups comprise a children age group in a range from 3 to 8 years old, a youngster age group in a range from 9 to 19, an adult age group in a range from 20 to 60 years old, and an elderly age group in a range from 61 to 80 years old.

5. The audio player of claim 4, wherein in the playing mode corresponding to the children group, a first maximum volume is about 70% of the predetermined maximum volume and the playing time length is about 30 minutes.

6. The audio player of claim 4, wherein in the playing mode corresponding to the youngster group, a second maximum volume is about 80% of the predetermined maximum volume and the playing time length is about 60 minutes.

7. The audio player of claim 4, wherein in the playing mode corresponding to the adult group, a third maximum volume is equal to the predetermined maximum volume and the playing time length is 120 minutes.

8. The audio player of claim 4, wherein in the playing mode corresponding to the elderly group, a fourth maximum volume is 120% of the predetermined maximum volume and the playing time length is 120 minutes.

9. The audio player of claim 1, wherein the audio player further comprises an earphone jack configured to provide a connection port to connect with an earphone and generate a detection signal when the earphone is connected with the earphone jack.

10. The audio player of claim 9, wherein the audio player further comprises a detector to detect the detection signal in the earphone jack and output the detection signal to the processor.

11. A control method for an audio player, comprising:
detecting a detection signal denoting whether an earphone is connected with an earphone jack;
determining whether the earphone is connected with the earphone jack according to the detection signal;
capturing a facial picture of a user;
analyzing the facial information of the facial picture to obtain an age group of the user;
selecting a playing mode from a pre-stored correspondence between the age group of the user and a playing mode of the audio player; and
controlling a volume and playing time length according to the playing mode.

12. The control method for audio player of claim 11, wherein when the detection signal is a logic high signal denoting the earphone is connected with the earphone jack.

13. The control method for audio player of claim 12, wherein the standard facial information is a pupil distance corresponding to different age groups.

14. The control method for audio player of claim 13, wherein in the standard facial information corresponding to different age groups, a children age group is set in a range from 3 to 8 years old, a youngster age group is set in a range from 9 to 19, an adult age group is set in a range from 20 to 60 years old, and an elder age group is set in a range from 61 to 80 years old.

15. The control method for audio player of claim 14, wherein the playing mode comprises a predetermined maximum volume and a playing time length.

16. The control method for audio player of claim 13, further comprising: when the playing time length is exceeded, stopping playing of the audio files and reminding the user pay attention to ear health.
